(19) United States
(12) Patent Application Publication
(10) Pub. No.: US 2004/0228236 A1
(43) Pub. Date: Nov. 18, 2004

(54) Optical pickup device

(75) Inventors: Keiji Sakai, Nara-shi (JP); Renzaburoh Miki, Soraku-gun (JP); Osamu Miyazaki, Soraku-gun (JP)

Correspondence Address: Dike, Bronstein, Roberts & Cushman, Intellectual Property Practice Group, Edwards & Angell, LLP, P.O. Box 9169, Boston, MA, 02209, US

(73) Assignee: Sharp Kabushiki Kaisha

(21) Appl. No.: 10/845,018

(22) Filed: May 12, 2004

(30) Foreign Application Priority Data
May 13, 2003 (JP) 2003-134728(P)
Aug. 22, 2003 (JP) 2003-298362(P)

(51) Int. Cl. G11B 7/135

(52) U.S. Cl. 369/44.41; 369/112.15

(57) ABSTRACT

An objective lens, an optical element in the form of a quarter wave plate, and an optical element having a polarizing diffraction grating including a phantom parting line in a track direction of a disk formed in a portion thereof, are configured to be driven integrally. The reflected light from the disk having traveled straight through the optical element without being diffracted is made incident on two sections provided at the hologram element, to thereby detect a tracking error signal. This ensures stable tracking servo performance, while suppressing degradation in luminous energy of the main beam and preventing occurrence of an offset with shift of the objective lens or tilt of the disk.

This nonprovisional application is based on Japanese Patent Applications Nos. 2003-134728 and 2003-298362 filed with the Japan Patent Office on May 13, 2003 and Aug. 22, 2003, respectively, the entire contents of which are hereby incorporated by reference.

### BACKGROUND OF THE INVENTION

1. Field of the Invention

The present invention relates to an optical pickup device for use in an optical disk device optically recording or reproducing information on an information recording medium such as an optical disk.

2. Description of the Background Art

Optical pickup devices using hologram elements as means for realizing downsizing, reduction in thickness and improvement in reliability thereof have been proposed (see, e.g., Japanese Patent Laying-Open Nos. 9-161282, 64-62838 and 1-144233). For example, the hologram element described in Japanese Patent Laying-Open No. 9-161282 is halved in a radial direction of a disk, and one half thereof is further halved in the track direction. Half the reflected beam from the disk is used for detection of a focus error signal, the other half is used for detection of a tracking error signal, and the entire beam is used for detection of an information signal. With the beam halved in the radial direction of the disk being further halved in the track direction, a positional signal with respect to the track (tracking error signal), or a so-called push-pull (PP) signal, can be detected.

An integrated unit employing the hologram element configured as above and objective lens means for converging the laser light emitted from the integrated unit onto the disk constitute the optical pickup device.

Further, a hologram described in Japanese Patent Laying-Open No. 10-269588 is halved in a radial direction of an optical disk, and each half is further halved in the track direction. Half the reflected beam from the optical disk is used to detect a focus error signal, and the entire reflected beam is used to detect an information signal. A tracking error signal is calculated by performing a comparison operation of phase difference between a sum signal of signals received at diagonally arranged two photodetectors and a sum signal of signals received at the other two photodetectors. This operation permits detection of a positional signal with respect to the track, or a so-called differential phase detection (DPD) signal.

However, since the DPD signal employs diffraction patterns from already recorded pits, a push-pull (PP) method or a differential push-pull (DPP) method is used for a track servo for an optical disk with no recorded information.

The optical pickup device is formed of an integrated unit using this hologram, and an objective lens for converging the light emitted from the integrated unit onto the optical disk.

The optical pickup device employing the integrated unit configured as above, however, poses the following problems. In the conventional optical pickup device, a two-section photodetector detects a difference in luminous energy distribution of the reflected light from the disk between the right and left sides (or, the inner and outer side portions in the radial direction of the track halved in the track direction) to generate the tracking error signal. If an objective lens is shifted in the radial direction, the optical axis of the reflected light from the disk is shifted accordingly, and thus, the beam center is shifted from the center of the two-section photodetector.

The beam center of the reflected light is also shifted due to tilt of the disk. Thus, in either case, even if tracking is normal, an offset occurs in the differential signal of the two-section photodetector, and it is determined as “out of track”.

Methods generally used for tracking servo include a 3-beam method as well as the above-described PP and DPP methods. These methods each detect a difference in luminous energy of a plurality of light receiving portions to detect the out-of-track amount, while determining the absence of such difference in luminous energy as “just track”.

The 3-beam method and the DPP method are widely used for tracking, since they can suppress an offset, which would occur in the PP method, by dividing the beam into three portions.

With these methods, however, three beams are obtained from a single light source. This causes reduction in luminous energy of the main beam for use in connection with recording, and, as a result, the recording speed decreases, hindering rapid recording.

### SUMMARY OF THE INVENTION

The present invention has been made to solve the above-described problems, and an object of the present invention is to provide an optical pickup device which ensures stable tracking servo performance without degradation in luminous energy of a main beam and without occurrence of an offset due to shift of an objective lens or tilt of a disk.

According to an aspect of the present invention, an optical pickup device includes an integrated unit, having a light emitting portion emitting light, a hologram element diffracting light reflected from an information recording medium and a light receiving portion receiving the light diffracted by the hologram element, and an objective lens for converging the light emitted from the integrated unit onto the information recording medium. The optical pickup device is characterized in that it includes: a first optical element arranged between the objective lens and the integrated unit and converting the reflected light from the information recording medium to light of a second polarized state that is different from a first polarized state corresponding to a polarized state of the light emitted from the integrated unit; and a second optical element arranged between the first optical element and the integrated unit and having at least a portion provided with a region preventing the light of the second polarized state from traveling straight therethrough. The second optical element and the objective lens are driven with their relative location kept constant.

With this configuration, part of the light of the second polarized state does not travel straight through the second optical element. Thus, the light of the second polarized state having traveled straight through the second optical element and incident on the hologram element forms a spot with a missing portion. Although the light incident on the hologram element moves thereon due to the shift of the objective lens or the tilt of the information recording medium, the shape itself does not change. Accordingly, luminous energies of the light of the second polarized state incident on sections of the hologram element separated by the missing portion do not change with the shift of the objective lens or the tilt of the information recording medium. In other words, constant tracking information of the information recording medium can be obtained regardless of shift of the objective lens or tilt of the information recording medium. Further, the light emitted from the integrated unit can be utilized without dividing the same. Accordingly, it is possible to provide an optical pickup device ensuring stable tracking servo performance, without degradation in luminous energy of a main beam or occurrence of an offset due to shift of an objective lens or tilt of an information recording medium.

Preferably, in the optical pickup device of this aspect of the present invention, the region provided at the second optical element and preventing the light of the second polarized state from traveling straight therethrough has a polarizing diffraction grating formed therein, which diffracts the light of the second polarized state.

With this configuration, the reflected light from the information recording medium incident on the region of the second optical element preventing the light of the second polarized state from traveling straight therethrough can be diffracted to enable erase, or conversely utilization, of the information included in the diffracted light.

Preferably, in the optical pickup device of this aspect of the present invention, the polarizing diffraction grating diffracts the light of the second polarized state incident from the first optical element to prevent it from entering the hologram element.

With this configuration, the information included in the light of the second polarized state diffracted by the polarizing diffraction grating can be removed more efficiently.

Alternatively, in the optical pickup device of this aspect of the present invention, the polarizing diffraction grating may diffract the light of the second polarized state incident from the first optical element to let it enter the hologram element.

With this configuration, it is possible to detect the information included in the light of the second polarized state traveled straight through the second optical element and the information included in the light of the second polarized state diffracted by the polarizing diffraction grating separately from each other.

Preferably, in the optical pickup device of this aspect of the present invention, the light receiving portion is configured to receive the light of the second polarized state having traveled straight through the second optical element and the light of the second polarized state diffracted by the polarizing diffraction grating, and output a signal for use in detecting a tracking error signal.

With this configuration, the offset due to the shift of the objective lens or the tilt of the information recording medium can be cancelled more efficiently in any cases including the case where the light from the light emitting portion has steep intensity distribution.

Preferably, in the optical pickup device of this aspect of the present invention, the first optical element is a quarter wave plate.

With this configuration, the first optical element can convert the light of the first polarized state to the light of the second polarized state orthogonal thereto. As such, the difference in angle of the polarized states can be maximized.

Preferably, in the optical pickup device of this aspect of the present invention, the light emitting portion is configured to emit light of the first polarized state.

With this configuration, the emitted light from the light emitting portion can wholly be utilized, which can further prevent degradation of luminous energy.

Preferably, in the optical pickup device of this aspect of the present invention, the region provided at the second optical element and preventing the light of the second polarized state from traveling straight therethrough is a portion where the ±1st-order diffracted light from the information recording medium does not enter.

The tracking information is included in the portion where the ±1st-order diffracted light is included, and the shift information of the objective lens and the tilt information of the information recording medium are included in the other portion. Thus, when the shift signal of the objective lens and/or the tilt signal of the information recording medium is erased or cancelled, the tracking error signal can be detected without reduction of the tracking signal component.

Preferably, in the optical pickup device of this aspect of the present invention, the region provided at the second optical element and preventing the light of the second polarized state from traveling straight therethrough includes a phantom parting line bisecting the second optical element in a track direction of the information recording medium and has its area bisected by the phantom parting line.

With this configuration, it is possible to separate the shift information of the objective lens (in the radial direction of the information recording medium) and the tilt information of the information recording medium in the radial direction that are included in the light of the second polarized state incident on the region provided at the second optical element and preventing the light of the second polarized state from traveling straight therethrough. Further, the operation for detecting the tracking error signal can be facilitated.

Still preferably, in the optical pickup device of this aspect of the present invention, the region provided at the second optical element and preventing the light of the second polarized state from traveling straight therethrough is formed in a region of the second optical element on one side of a phantom parting line bisecting the second optical element in a radial direction of the information recording medium and between two straight lines at equal distances from the phantom parting line bisecting the second optical element in the track direction of the information recording medium.

With this configuration, the region provided at the second optical element and preventing the light of the second polarized state from traveling straight therethrough is simple in shape, which further facilitates fabrication of the second optical element. The maximum permissible shift amount of the objective lens or the maximum permissible tilt amount of the information recording medium is associated with the shortest width of the region of the second optical element preventing the light of the second polarized state from traveling straight therethrough, which region is formed between two straight lines at equal distances from the phantom parting line in the track direction of the information recording medium. Thus, the maximum permissible shift amount of the objective lens or the maximum permissible tilt amount of the information recording medium can be estimated from the distance between the two straight lines more easily.

Still preferably, in the optical pickup device of this aspect of the present invention, the hologram element is a three-section hologram element that is divided into two sections by a parting line in the radial direction of the information recording medium and one of the two sections corresponding to the side on which the region preventing the light of the second polarized state from traveling straight therethrough is provided at the second optical element is further divided into two sections by a parting line in the track direction of the information recording medium.

With this configuration, the tracking error signal can be obtained using the two sections divided by the parting line in the track direction of the information recording medium, and the focus error signal can be obtained using the remaining sections.

According to another aspect of the present invention, an optical pickup device includes an integrated unit, having a light emitting portion emitting light, a hologram element diffracting light reflected from an optical disk to guide the light to a light receiving portion, and the light receiving portion receiving the light diffracted by the hologram element, and an objective lens for converging the light emitted from the light emitting portion of the integrated unit onto the optical disk. The optical pickup device is characterized in that it includes a first optical element arranged between the objective lens and the integrated unit, and a second optical element arranged between the first optical element and the integrated unit. The second optical element has a diffracting portion diffracting a portion of the reflected light from the optical disk. The diffracting portion has anisotropy in polarization to transmit light of a first linearly polarized state therethrough and to diffract light of a second linearly polarized state having a polarized direction orthogonal to that of the first linearly polarized state. The first optical element converts the polarized state of the reflected light from the optical disk to the second linearly polarized state. The first and second optical elements and the objective lens are provided integrally.

Preferably, in the optical pickup device of this aspect of the present invention, the first optical element is a quarter wave plate that converts the first linearly polarized state to a circularly polarized state, and converts the circularly polarized state to the second linearly polarized state.

Preferably, in the optical pickup device of this aspect of the present invention, the diffracting portion of the second optical element is a polarizing diffraction grating that is provided at only a portion of the second optical element corresponding to a portion of the reflected light of the optical disk.

Preferably, in the optical pickup device of this aspect of the present invention, the polarizing diffraction grating constituting the diffracting portion of the second optical element is formed of a lithium niobate substrate having periodically arranged grooves on its surface and proton exchange regions provided in the grooves.

Preferably, in the optical pickup device of this aspect of the present invention, a portion of the reflected light of the optical disk diffracted by the diffracting portion of the second optical element and another portion of the reflected light of the optical disk transmitted through the second optical element are both made incident on the hologram element of the integrated unit.

Preferably, in the optical pickup device of this aspect of the present invention, the diffracting portion of the second optical element is provided on one of two portions of the second optical element divided by a parting line in a radial direction of the optical disk.

Preferably, in the optical pickup device of this aspect of the present invention, the light emitting portion emits laser light of the first linearly polarized state.

Preferably, in the optical pickup device of this aspect of the present invention, the hologram element of the integrated unit is a four-section hologram element that is divided into two sections by a parting line in a radial direction of the optical disk and further divided into two sections by a parting line in a track direction of the optical disk.

Preferably, in the optical pickup device of this aspect of the present invention, the light receiving portion of the integrated unit is divided into at least four sections in response to the diffracted light divided into four portions by the hologram element.

Preferably, in the optical pickup device of this aspect of the present invention, the reflected light of the optical disk transmitted through the second optical element without diffraction is further divided into two portions by the parting line in the optical disk radial direction of said hologram element.

Preferably, in the optical pickup device of this aspect of the present invention, the light receiving portion is divided into a plurality of sections, and a first tracking error signal, generated from a signal of the section of the light receiving portion where the reflected light of the optical disk transmitted through the second optical element without diffraction enters, and a second tracking error signal, generated from a signal of the section of the light receiving portion where the reflected light of the optical disk diffracted by the second optical element enters, are used to perform an operation to detect a third tracking error signal for use in tracking.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross sectional view showing a schematic configuration of an optical pickup device according to the present invention.

FIG. 2 is a plan view of a second optical element included in the optical pickup device according to a first embodiment of the present invention.

FIG. 3 is a perspective view of a polarizing diffraction grating included in the optical pickup device.

FIG. 4 is a cross sectional view of the polarizing diffraction grating included in the optical pickup device.

FIG. 5 is a cross sectional view of a schematic configuration of the optical pickup device, showing a beam direction of light reflected from a disk.

FIG. 6 illustrates the relation between a hologram element, a light receiving portion, and light reflected from a disk.

FIG. 7A is a plan view of a hologram element in a conventional optical pickup device, shown with the reflected light incident thereon, and FIG. 7B is a plan view of a hologram element in an optical pickup device of the present invention, shown with the reflected light incident thereon.

FIG. 8 illustrates the relation between a hologram element, a light receiving portion, and light reflected from a disk.

FIG. 9A is a plan view of a hologram element with diffracted light of a polarizing diffraction grating incident thereon in the absence of shift of an objective lens, and FIG. 9B is a plan view of the hologram element with the diffracted light of the polarizing diffraction grating incident thereon in the presence of shift of the objective lens.

FIGS. 10-13 are plan views showing various modifications of the polarizing diffraction grating according to the present embodiment.

FIG. 14 illustrates the relation between a hologram element, a light receiving portion, and light reflected from a disk.

FIG. 15 shows a structure of a second optical element according to a second embodiment of the present invention.

FIG. 16 shows a structure of a polarizing diffraction grating.

FIG. 17 shows a function of the polarizing diffraction grating.

FIG. 18 is a side view showing an operation of an optical pickup device of the present embodiment.

FIG. 19 is a block diagram showing processing of signals from a light receiving portion.

FIG. 20 illustrates the relation between a conventional hologram element and light reflected from an optical disk.

FIGS. 21A and 21B show the relation between the position of the reflected light on the hologram element and intensity distribution on the second optical element before and after shift of the objective lens, respectively.

FIGS. 22A and 22B show the position of the reflected light on the hologram element, FIGS. 22C and 22D show the intensity distribution of the emitted light on the second optical element, and FIGS. 22E and 22F show the intensity distribution of the reflected light on the second optical element, before and after shift of the objective lens, respectively.

FIG. 23 is a block diagram showing processing of signals from a light receiving portion.

FIG. 24 shows TES1 and TES2 under a prescribed condition.

FIG. 25 shows TES1, TES2 and TES3 with a value of K optimized.

### DESCRIPTION OF THE PREFERRED EMBODIMENTS

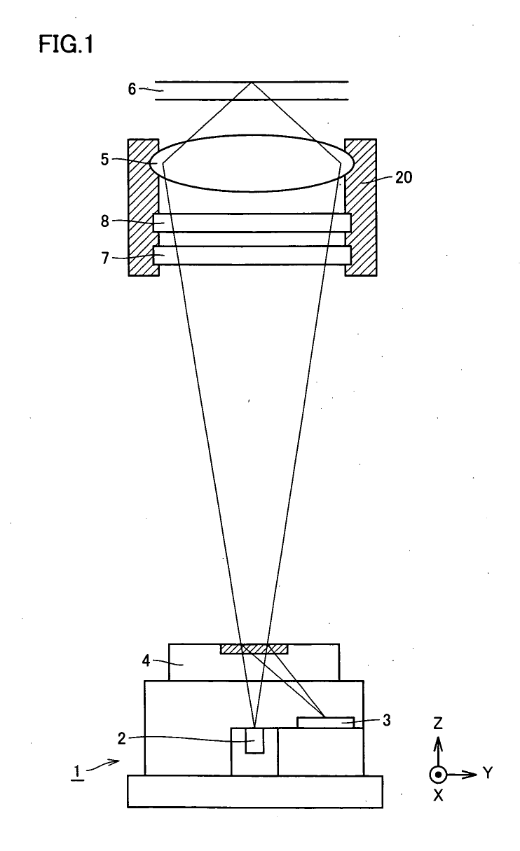

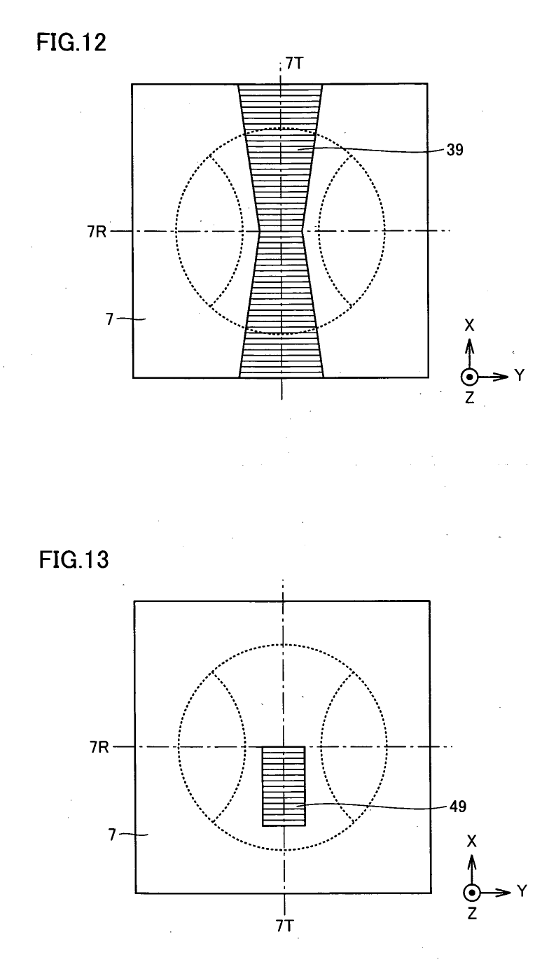

Hereinafter, an optical pickup device according to a first embodiment of the present invention is described with reference to FIGS. 1-14.

FIG. 1 schematically shows a configuration of the optical pickup device of the present embodiment. An integrated unit 1 has a light emitting portion 2 emitting laser light, such as a LD chip, a light receiving portion 3, and a hologram element 4.

An objective lens 5, an optical element (first optical element) 8 and another optical element (second optical element) 7 are secured to a holder 20 in this order, so that they can be driven integrally for focusing or tracking. Holder 20 is arranged such that optical element 7 faces integrated unit 1.

A disk 6 as an information recording medium is located on a side of objective lens 5 opposite to the side facing integrated unit 1.

In FIG. 1, the X direction corresponds to a track direction of disk 6, the Y direction corresponds to a radial direction of disk 6, and the Z direction corresponds to a direction orthogonal to the X and Y directions. The same applies to the other drawings.

Light emitting portion 2 is configured to emit linearly polarized light having a prescribed polarized state (a first polarized state). For example, light emitting portion 2 emits linearly polarized light having its polarized direction corresponding to the track direction of disk 6 (i.e., the X direction in the drawing).

Light receiving portion 3 is for converging and receiving the +1st-order diffracted light from hologram element 4. Light receiving portion 3 includes a plurality of detectors (as will be described later) detecting luminous energy of the received light.

Hologram element 4 is for diffracting light reflected from disk 6 and incident thereon such that it enters light receiving portion 3. Normally, hologram element 4 is divided into a plurality of portions, as will be described later.

Objective lens 5 serves to converge the incident light.

Optical element 8 is a quarter wave plate, for example. As such, the linearly polarized light incident to optical element 8 is converted to circularly polarized light.

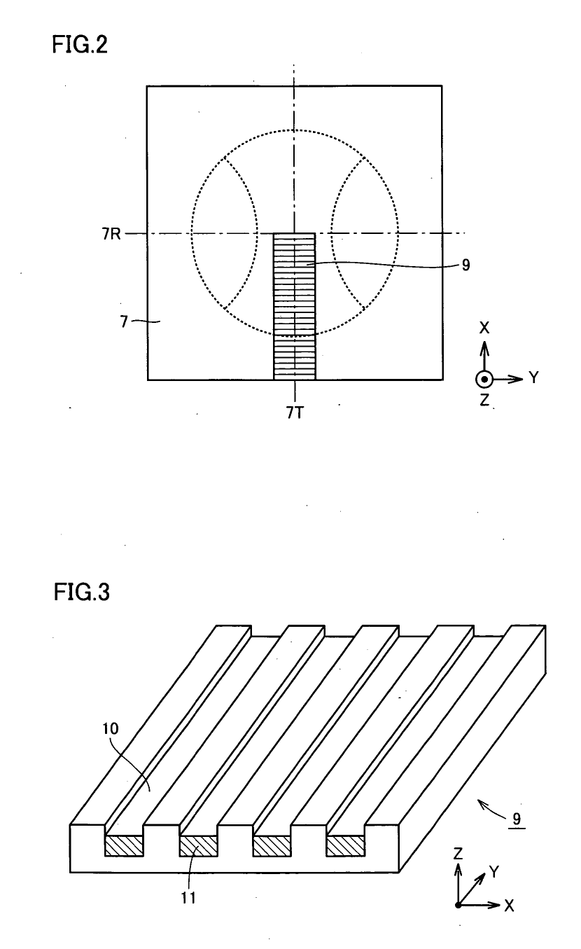

FIG. 2 is a plan view of optical element 7. Optical element 7 has a polarizing diffraction grating 9 having a polarizing characteristic formed only in a portion thereof. Polarizing diffraction grating 9 is formed in a region on a half of optical element 7 bisected by a phantom parting line 7R in a direction corresponding to the radial direction of disk 6 (Y direction in FIG. 2), and between two straight lines sandwiching and at equal distances from a phantom parting line 7T bisecting optical element 7 in a direction corresponding to the track direction of disk 6 (X direction in FIG. 2). In this case, polarizing diffraction grating 9 is in a rectangular shape, which can be formed relatively easily. Further, polarizing diffraction grating 9 is formed in a region not including the ±1st-order diffracted light from disk 6. The remaining region of optical element 7 unprovided with polarizing diffraction grating 9 is formed of a material of good transmittance to let the incident light travel straight therethrough regardless of the polarized state thereof.

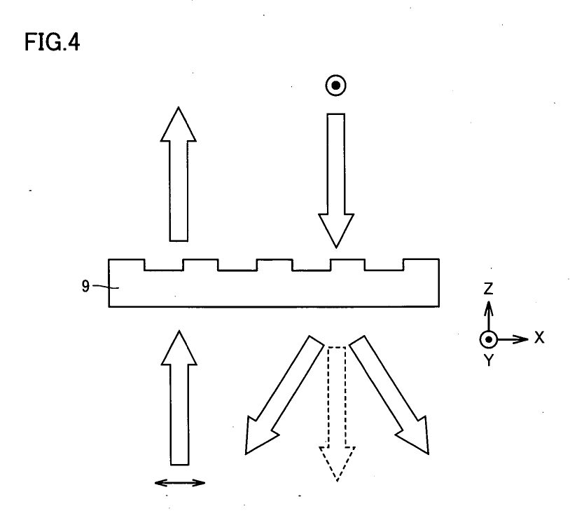

Polarizing diffraction grating 9 having the polarizing characteristic is formed, e.g., of a lithium niobate substrate. As shown in FIG. 3, polarizing diffraction grating 9 has a periodic concavo-convex grating 10 on its surface, and a proton exchange region 11 is formed in the concave portion. When the groove depth of the concave portion and the depth of the proton exchange layer are controlled appropriately, a difference between the optical path lengths of the convex and concave portions becomes “an integer multiple of wavelength” for linearly polarized light having a polarized direction that is perpendicular to the groove direction (corresponding to the X direction in FIG. 3). For linearly polarized light having a polarized direction that is parallel to the groove direction (corresponding to the Y direction in FIG. 3), the difference between the optical path lengths of the convex and concave portions becomes “an integer multiple of wavelength+a half wavelength”.

More specifically, as shown in FIG. 4, polarizing diffraction grating 9 causes the linearly polarized light having the polarized direction perpendicular to the groove direction (or the X direction in the drawing) to travel straight therethrough, while it diffracts the linearly polarized light having-the polarized direction parallel to the groove direction (or the Y direction in FIG. 4). As such, it is possible to change the polarized direction of the linearly polarized light allowed to travel straight through polarizing diffraction grating 9 according to the formation direction of the grating. In the present embodiment, for example, polarizing diffraction grating 9 is formed on optical element 7 such that the polarized direction of the linearly polarized light allowed to travel straight therethrough coincides with the polarized direction of the linearly polarized light emitted from light emitting portion 2. That is, the linearly polarized light having the polarized direction parallel to the track direction of disk 6 is transmitted straight through polarizing diffraction grating 9, whereas the linearly polarized light having the polarized direction parallel to the radial direction of disk 6 is diffracted by polarizing diffraction grating 9.

At this time, the polarized light is diffracted by polarizing diffraction grating 9 in a direction in accordance with a period of the grating. This means that the diffracted direction can be changed according to the period of the grating.

A traveling path of linearly polarized light (emitted light) having a polarized direction parallel to the track direction of disk 6 (or the X direction in the drawings) emitted from light emitting portion 2 is now described with reference to FIGS. I and 5.

As shown in FIG. 1, the emitted light is transmitted through hologram element 4 without being divided. Thereafter, the 0th-order light of hologram element 4 enters optical element 7. Here, as described above, the polarized direction of the linearly polarized light allowed to travel straight through polarizing diffraction grating 9 provided at a portion of optical element 7 coincides with the polarized direction of the emitted light. Thus, the emitted light incident on optical element 7 is wholly transmitted straight therethrough.

The emitted light having traveled straight through optical element 7 then enters optical element 8. Here, when optical element 8 is a quarter wave plate as described above, the emitted light is converted to circularly polarized light. When the circularly polarized light enters objective lens 5, it is converged on disk 6. Thereafter, the circularly polarized light reflected from disk 6 is transmitted again through objective lens 5, and enters optical element 8. The circularly polarized light reflected from disk 6 is then converted to linearly polarized light (reflected light transmitted through optical element 8) having a polarized direction (which corresponds to a second polarized state) orthogonal to the polarized direction of the emitted light. It is noted that since the polarized direction of the emitted light is in parallel with the track direction of disk 6, the polarized direction of the reflected light transmitted through optical element 8 becomes parallel to the radial direction of disk 6.

The reflected light transmitted through optical element 8 then enters optical element 7. Here, polarizing diffraction grating 9 functions to diffract the linearly polarized light having the polarized direction parallel to the radial direction of disk 6. Thus, the reflected light transmitted through optical element 8 and incident on this polarizing diffraction grating 9 undergoes diffraction. On the other hand, the reflected light transmitted through optical element 8 and incident on the region of optical element 7 unprovided with polarizing diffraction grating 9 travels straight therethrough without experiencing diffraction.

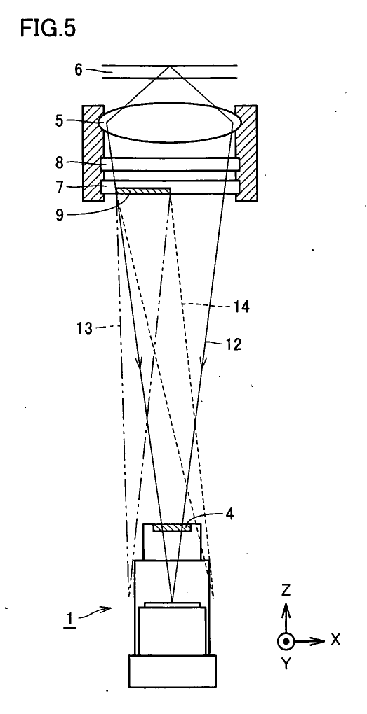

A beam direction of the reflected light of disk 6 is now described with reference to FIG. 5. Of the reflected light transmitted through optical element 8, the light incident on polarizing diffraction grating 9 formed at optical element 7 is diffracted into a beam 13 as the +1st-order diffracted light and a beam 14 as the −1st-order diffracted light. The linearly polarized light incident on the region of optical element 7 unprovided with polarizing diffraction grating 9 travels straight therethrough, and becomes a beam 12. The beam directions (traveling directions) of beams 13 and 14 may be determined according to the period of grating of polarizing diffraction grating 9, as described above. Here, polarizing diffraction grating 9 is configured to let beam 12 incident on hologram element 4 while prohibiting beams 13 and 14 from entering hologram element 4.

As described above, polarizing diffraction grating 9 is arranged in a region not including the ±1st-order diffracted light from disk 6. Tracking information is included in a portion of the light where the ±1st-order diffracted light from disk 6 is included, while shift information of objective lens 5 in the radial direction or tilt information of disk 6 in the radial direction are included in the remaining portion. Thus, by letting beam 12 including the tracking information incident on hologram element 4, it is possible to ensure detection of a tracking error signal, without a decrease of the tracking signal component.

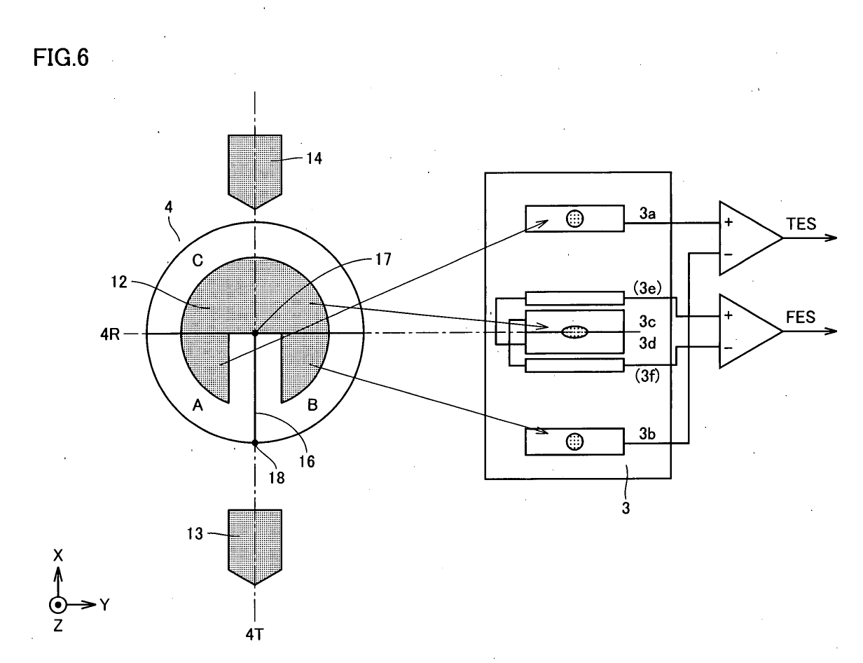

FIG. 6 shows the relation between hologram element 4, light receiving portion 3 and beams 12, 13 and 14. As shown in FIG. 6, hologram element 4 is divided into three sections A, B and C by a parting line 4R in the radial direction of disk 6 (corresponding to the Y direction in the drawing) and a parting line 4T in the track direction of disk 6 (corresponding to the X direction in the drawing).

Beam 12 having traveled straight through the region of optical element 7 unprovided with polarizing diffraction grating 9 enters the respective sections A, B and C of hologram element 4, while beams 13 and 14 diffracted by polarizing diffraction grating 9 are made incident on regions outside hologram element 4 located on an extended line of parting line 4T. Here, the shapes of sections A and B are symmetrical to each other with respect to parting line 4T. Further, beam 12 is prevented from entering end portions of sections A and B on the side of parting line 4T (corresponding to the line segment connecting points 17 and 18 in the drawing). In other words, there is a portion where beam 12 does not enter between the incident portion of beam 12 in section A and the incident portion of beam 12 in section B.

In the case of a conventional optical pickup device not including an optical element having a polarizing diffraction grating provided in a portion thereof, beam 12 would enter the hologram element in a circular form. By comparison, according to the present embodiment provided with optical element 7 as described above, beam 12 enters hologram element 4 to form a circular spot with a missing portion. This missing portion is similar in shape to the region of polarizing diffraction grating 9 where the reflected light transmitted through optical element 8 enters.

Light receiving portion 3 has photodetectors 3a, 3b, 3c, 3d, 3e and 3f. Of beam 12, the light diffracted at section A of hologram element 4 is converged onto photodetector 3a, and the light diffracted at section B of hologram element 4 is converged onto photodetector 3b. The light diffracted at section C of hologram element 4 is converged onto bisected photodetectors 3c and 3d, or onto quartered photodetectors 3c, 3d, 3e and 3f.

The optical pickup device of the present embodiment includes an operation unit that operates outputs from the photodetectors. The operation unit can use outputs S3a, S3b from photodetectors 3a, 3b to perform a differential operation (S3a−S3b) to detect a tracking error signal (TES).

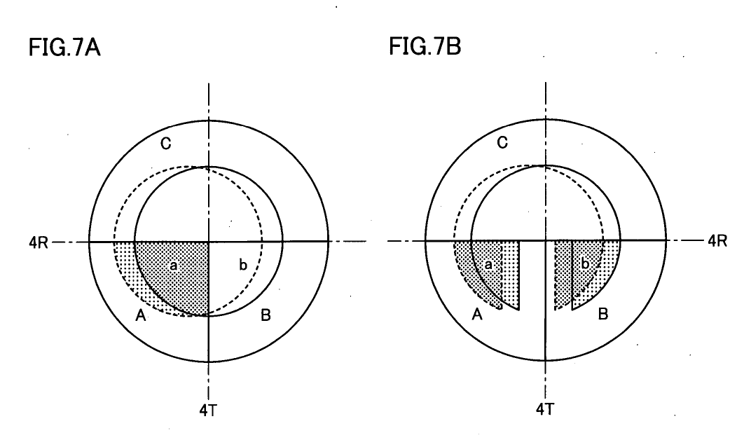

Hereinafter, the principle by which occurrence of an offset is suppressed even if objective lens 5 is shifted during tracking is described with reference to FIGS. 7A and 7B. FIG. 7A shows the relation between the hologram element and the reflected light from the disk according to a conventional configuration. The area of light incident on section A of the hologram element is represented as an area a, and the area of light incident on section B of the hologram element is represented as an area b. The tracking error signal detects the output difference obtained from the luminous energies incident on sections A and B of the hologram element. More specifically, the tracking error signal is detected based on the area difference between the area a of the incident reflected light in section A and the area b of the incident reflected light in section B.

Assume that the objective lens is shifted in the just-track state. In this case, area a increases and area b decreases, since the reflected light of the disk on the hologram element also moves as shown with the dotted line. This causes a difference between areas a and b even in the just-track state. As such, the tracking error signal, which is TES=0 when the objective lens is not shifted, becomes TES=S3a−S3b≠0 when the objective lens is shifted. Namely, TES varies and causes an offset depending on the presence/absence of shift of the objective lens.

FIG. 7B shows the relation between hologram element 4 and beam 12 incident on sections A and B thereof according to the configuration of the present embodiment. In the case of the just-track state with no shift of objective lens 5, beam 12 enters section A in a portion (having area a) shown with shaded lines, and also enters section B in a portion (having area b) shown with shaded lines, which portions are separated by a portion where beam 12 does not enter and are symmetrical to each other with respect to parting line 4T. This is because of the facts that the portion of optical element 7 through which the reflected light travels straight to be beam 12 and the portion of hologram element 4 into which beam 12 enters are similar in-shape to each other, and that in the case of the just-track state, of the reflected light having transmitted through optical element 8, the light traveled straight through phantom parting lines 7T, 7R of optical element 7 enter parting lines 4T, 4R of hologram element 4. Here, since polarizing diffraction element 9 is bisected by phantom parting line 7T, areas a and b are inherently equal to each other. Thus, in this case, tracking error signal TES is 0.

Now, assume that objective lens 5 is shifted in the just-track state, as in the case of FIG. 7A. In the present embodiment, objective lens 5 and optical element 7 are secured to holder 20, and move together with their relative location kept constant, as described above. Thus, when objective lens 5 is shifted, optical element 7 is also shifted by the same amount, and consequently, beam 12 moves on hologram element 4 as shown with the dotted line. At this time, however, the portion where beam 12 does not enter located between the portions of sections A and B where beam 12 enters also moves. As long as parting line 4T is included in this portion as shown in FIG. 7B, the incident area a of beam 12 on section A and the incident area b of beam 12 on section B do not change, and accordingly, TES=S3a−S3b=0 holds irrelevant to the shifted amount of objective lens 5. As such, the TES the same as in the case of no shift of objective lens 5 can be obtained, so that no offset occurs.

In the case where disk 6 is tilted in the radial direction, beam 12 incident on hologram element 4 moves as in the case of FIG. 7B. Thus, no offset occurs.

Here, the maximum amount of shift of objective lens 5 without occurrence of offset corresponds to its shift amount at the time when the incident area of beam 12 on section A or the incident area of beam 12 on section B begins to change. Since the shifted direction of objective lens 5 corresponds to the radial direction of disk 6, the shortest width in the radial direction of the portion of section A (or section B) where beam 12 does not enter affects the maximum shift amount of objective lens 5. This is because, as the shift amount of objective lens 5 is increased, the shortest width becomes 0 the earliest, leading to a change of area a (or area b).

In the present embodiment, the shortest width of the portion of section A (or section B) where beam 12 does not enter corresponds to half the distance between the portions (having areas a and b) of sections A and B where beam 12 enters. Thus, the distance between beams 12 incident on sections A and B- may be determined in accordance with the shift amount of objective lens 5. The distance between beam 12 incident on section A and beam 12 incident on section B depends on the size of polarizing diffraction grating 9 provided at optical element 7. That is, changing the size of polarizing diffraction grating 9 can determine the distance between the reflected light incident on section A and the reflected light incident on section B.

For example, in the present embodiment, the shift amount of objective lens 5 is ±0.3 mm, which corresponds to ±20 μm on hologram element 4. Polarizing diffraction grating 9 has a width of 800 μm, with which the width of the portion on hologram element 4 where beam 12 does not enter becomes greater than 40 μm. Thus, the offset of the tracking error signal caused by the normally expected shift of objective lens 5 can be cancelled.

Further, outputs S3c-S3f from photodetectors 3c-3f may be employed to perform a similar differential operation as in the case of the tracking error signal, to detect a focus error signal (FES). When beam 12 incident on section C is halved, the common knife-edge method can be used to detect FES based on FES=S3c−S3d. When disk 6 is a double-layered disk as the DVD standard, for the purpose of accurate focusing, beam 12 incident on section C is quartered to detect FES based on FES=−S3c+S3d+S3e−S3f.

As described above, the optical pickup device of the present embodiment has an integrated unit 1 and an objective lens 5. Integrated unit 1 has a light emitting portion 2 emitting linearly polarized light (having a first polarized state), a hologram element 4 diffracting light reflected from a disk 6 as an information recording medium, and a light receiving portion 3 receiving the light diffracted by hologram element 4. Objective lens 5 converges the light having the first polarized state onto disk 6. The optical pickup device includes an optical element (first optical element) 8 arranged between objective lens 5 and integrated unit 1 and converting the reflected light from disk 6 into light of a second polarized state that is different from the polarized state (first polarized state) of the light emitted from integrated unit 1, and an optical element (second optical element) 7 arranged between optical element 8 and integrated unit 1 and having a region preventing the light of the second polarized state from traveling straight therethrough in at least a portion thereof. Optical element 7 and objective lens 5 are driven with their relative location kept constant.

With this configuration, part of the light in the second polarized state does not travel straight through optical element 7. Thus, the light in the second polarized state having traveled straight through optical element 7 and incident on hologram element 4 forms a spot with a missing portion. Although the light incident on hologram element 4 moves thereon due to shift of objective lens 5 or tilt of disk 6, the shape itself does not change, and thus, luminous energy of the light of the second polarized state incident on sections A and B of hologram element 4 with the missing portion remains unchanged with the shift of objective lens 5 or the tilt of disk 6. In other words, consistent tracking information can be obtained regardless of shift of objective lens 5 or tilt of disk 6. Further, the light emitted from integrated unit 1 can be utilized without dividing the same. As such, it is possible to provide an optical pickup device ensuring stable tracking servo performance, without degradation in luminous energy of the main beam or occurrence of an offset due to shift of objective lens 5 or tilt of disk 6.

As described above, performing the differential operation (S3a−S3b) enables detection of TES hardly suffering an offset due to shift of objective lens 5 or tilt of disk 6. However, if the emitted light from light emitting portion 2 has steep intensity distribution in the radial direction of disk 6, for example, the offset cannot be cancelled completely with the differential operation (S3a−S3b).

To address this problem, the period of grating of polarizing diffraction grating 9, having been set to prevent beams 13 and 14 including shift information of objective lens 5 in a large amount from entering hologram element 4 in the above configuration, may be set to make beams 13 and 14 incident on hologram element 4.

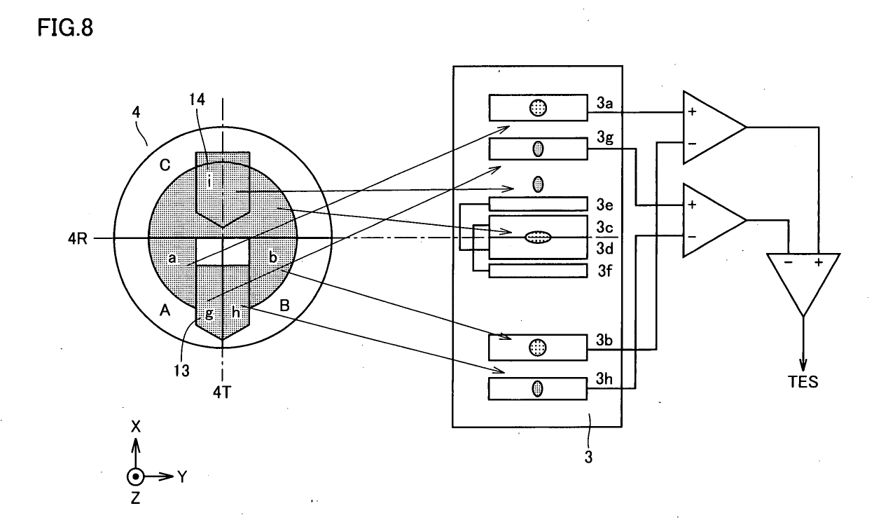

FIG. 8 shows the relation between hologram element 4 and light receiving portion 3 in the case where the reflected light is diffracted by polarizing diffraction grating 9 such that beams 13 and 14 are incident on hologram element 4. Note that in the following description, disk 6 is in a just track state unless otherwise specified.

As shown in FIG. 8, beam 13 is incident on hologram element 4 across sections A and B, while beam 14 is incident on section C. Here, the incident area of beam 13 on section A, the incident area of beam 13 on section B, and the incident area of beam 14 on section C are represented as g, h and i, respectively.

While areas a and g are both included in section A, beam 12 incident on area a and beam 13 incident on area g have different beam directions with respect to hologram element 4. Naturally, the +1st-order diffracted light from hologram element 4 have different beam directions for beams 12 and 13 incident on section A, and thus, they are converged onto light receiving portion 3 at different positions. Similarly, the diffracted light from the hologram element corresponding to beams 12 and 13 incident on section B, and the diffracted light from the hologram element corresponding to beams 12 and 14 incident on section C, are converged onto light receiving portion 3 at different positions. Here, photodetector 3g is provided at the position where the +1st-order diffracted light corresponding to beam 13 incident on section A is converged, and photodetector 3h is provided at the position where the +1st-order diffracted light corresponding to beam 13 incident on section B is converged. When the outputs of photodetectors 3g and 3h are represented as S3g and S3h, respectively, the area ratio among area a of beam 12 incident on section A, area g of beam 13 incident on section A, area b of beam 12 incident on section B, and area h of beam 13 incident on section B can be detected using the values of S3a, S3g, S3b and S3h. As such, the luminous energies of beams 12 and 13 incident on the same section A can be detected separately by virtue of their difference in beam direction.

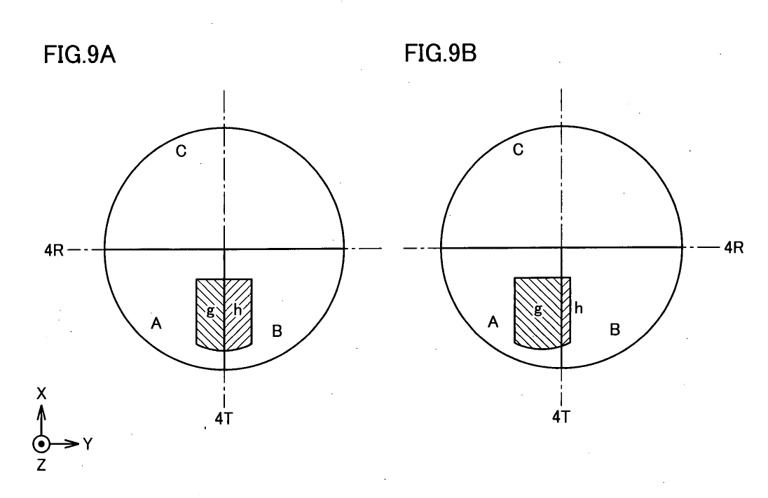

FIGS. 9A and 9B each show beam 13 incident on hologram element 4. FIG. 9A corresponds to the case of no shift of objective lens 5, where areas g and h are equal to each other. FIG. 9B corresponds to the case with objective lens 5 shifted, where area g is larger than area h. Here, with the conventional configuration as shown in FIG. 7A, the area change amount (a−b) by the shift of objective lens 5 with respect to area (a+b) is small. By comparison, with the configuration of the present embodiment as shown in FIG. 9B, the area change amount (g−h) with respect to area (g+h) is large. Thus, performing the differential operation (S3g−S3h) by the operation unit enables highly sensitive detection of the signal corresponding to the shift of objective lens 5.

Here, in the expression of

TES=(S3a−S3b)−k×(S3g−S3h)

representing the operation of the operation unit, when the value k is optimized, the offset due to the shift of objective lens 5 can be cancelled more effectively in any cases including the case where the laser light from light emitting portion 2 includes steep intensity distribution in the radial direction of disk 6.

Further, optical element 8 is integrated with objective lens 5 and optical element 7 via holder 20 in the above configuration. However, optical element 8 does not necessarily have to be integrated therewith. All that is needed is that optical element 8 is located between objective lens 5 and optical element 7.

Further, although objective lens 5 and optical element 7 are integrated with each other via holder 20, not limited thereto, any other configuration may be implemented as long as a constant relative location is always held between objective lens 5 and optical element 7.

In the above configuration, polarizing diffraction grating 9 is formed of a lithium niobate substrate. Periodic convexo-concave grating 10 is formed on its surface, and proton exchange region 1 1 is formed in the concave portion. However, the present invention is not limited thereto. For example, polarizing diffraction grating 9 may be formed of an anisotropic material such as a liquid crystal material or resin film.

Further, in the above configuration, light emitting portion 2 emits light of a first polarized state. Although this is a preferable configuration ensuring efficient utilization of the light emitted from light emitting portion 2, the present invention is not limited thereto. For example, integrated unit 1 may include an additional optical element that converts light emitted from light emitting portion 2 into the light of the first polarized state.

In the above configuration, polarizing diffraction grating 9 having a polarizing characteristic is formed in a portion of optical element 7. This is a preferable configuration since the reflected light from disk 6 incident on polarizing diffraction grating 9 can be diffracted to allow erase or utilization of the information included in the diffracted light. However, not limited thereto, a polarizing plate may replace polarizing diffraction grating 9. In this case, the polarizing plate is provided to optical element 7 such that it transmits the linearly polarized light from integrated unit 1 and blocks the light of the second polarized state transmitted through optical element 8. With this configuration, again, beam 12 having traveled straight through the region of optical element 7 unprovided with the polarizing plate enters hologram element 4 to form a circular spot with a missing portion, and thus, an offset due to shift of objective lens 5 or tilt of disk 6 can be cancelled.

Further, in the above configuration, polarizing diffraction grating 9 is set in a region of optical element 7 not including the ±1st-order diffracted light from disk 6. This is a preferable configuration for minimizing reduction of the tracking information included in the portion of the light where the ±1st-order diffracted light is included. However, polarizing diffraction grating 9 may be set in a region of optical element 7 including part of the ±1st-order diffracted light from disk 6, to the extent that reading of the tracking information is guaranteed. In this case, again, there is formed a portion on hologram element 4 including parting line 4T and suppressing incoming of beam 12 therein between the incident portion (area a) of beam 12 on section A and the incident portion (area b) of beam 12 on section B. Thus, an offset due to shift of objective lens 5 can be cancelled.

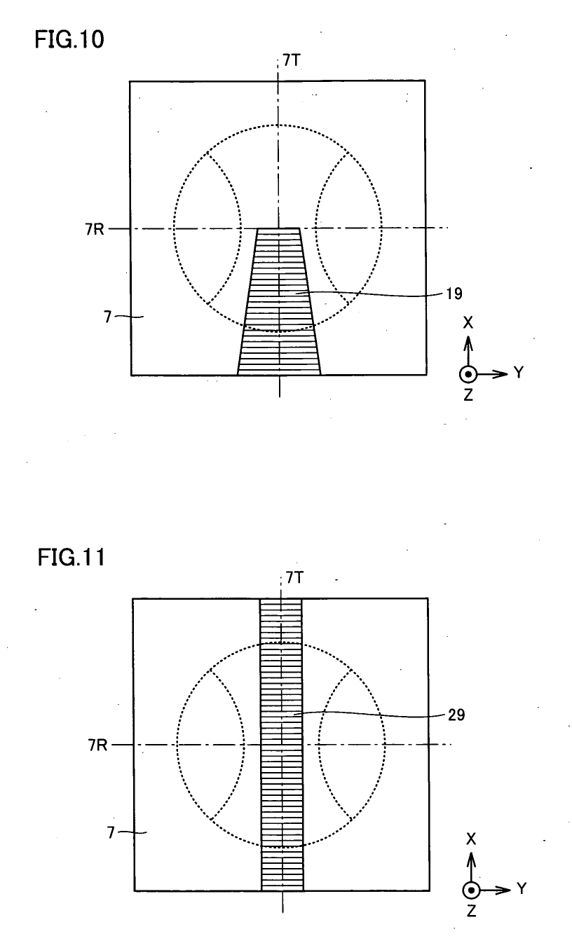

In the above configuration, polarizing diffraction grating 9 on optical element 7 is in a rectangular shape, as shown in FIG. 2. However, not limited thereto, a trapezoidal polarizing diffraction grating 19 as shown in FIG. 10 may be provided. Further, not limited to one side of optical element 7 halved by phantom parting line 7R, polarizing diffraction gratings 29, 39 as shown in FIG. 11, 12 may be formed. In the case where optical element 7 is formed as shown in any of FIGS. 10, 11 and 12, hologram element 4 having sections A, B and C as shown in FIG. 6 may be employed, since a space including parting line 4T occurs between areas a and b of sections A and B where beam 12 enters, and thus, tracking error signal TES can be obtained with an offset due to shift of objective lens 5 cancelled.

Although sections A and B are divided by parting line 4T in the above configuration, the present invention is not limited thereto. All that is needed is that sections A and B are divided by a line included in a portion (where beam 12 does not enter) between areas a and b of sections A and B where beam 12 enters, or by a line included in the missing portion of the spot formed by beam 12 incident on hologram element 4.

Further, as another modification of optical element 7, a polarizing diffraction grating 49 may be formed in the vicinity of the center of the 0th-order diffracted light from disk 6, as shown in FIG. 13. In this case, however, sections of hologram element 4 should be modified in accordance with the shape of optical element 7.

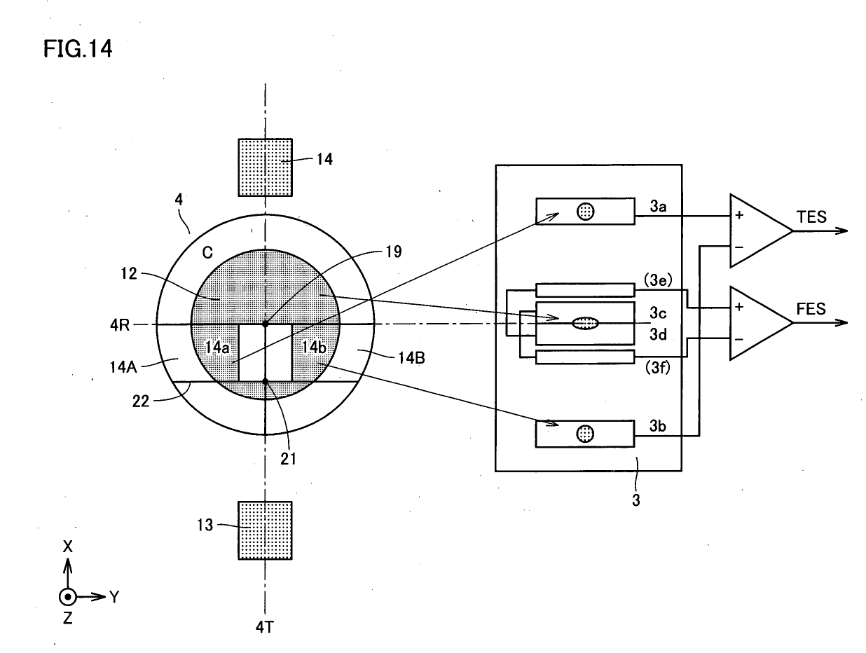

FIG. 14 shows beam 12 having traveled straight through optical element 7 shown in FIG. 13 and hologram element 4. There is a line segment (connecting points 19 and 21) on parting line 4T of hologram element 4 corresponding to a portion where beam 12 does not enter. Here, as shown in FIG. 14, a portion of hologram element 4 located between a straight line (corresponding to parting line 4R itself) including point 19 and parallel to parting line 4R and a straight line 22 including point 21 and parallel to parting line 4R is divided by parting line 4T into two sections 14A and 14B. A space where beam 12 does not enter occurs between the incident region (area 14a) of beam 12 on section 14A and the incident region (area 14b) of beam 12 on section 14B. That is, beam 12 does not enter in the end portions of segments 14A and 14B on the side of parting line 4T (or the line segment connecting points 19 and 21). As such, by providing photodetectors 3a and 3b to detect luminous energies of beams 12 incident on sections 14A and 14B, respectively, it is possible to obtain tracking error signal TES with an offset due to shift of objective lens 5 cancelled.

Further, in the above configuration, polarizing diffraction grating 9 is shaped such that it includes phantom parting line 7T with which the area thereof is exactly halved. This is a preferable configuration since beam 12 enters portions of sections A and B that are equal in area, and thus, TES=0 holds when disk 6 is in the just track state and there is no shift of objective lens 5 or tilt of disk 6, further facilitating detection of the tracking error information. However, not limited thereto, all that is needed is that polarizing diffraction grating 9 is formed in a portion of optical element 7. For example, if the area of optical element 7 is not bisected by phantom parting line 7T, TES becomes m (not 0) even if there is no shift of objective lens 5. However, with the presence of polarizing diffraction grating 9, TES becomes m even if there is shift of objective lens 5, so that consistent TES can be obtained regardless of the presence/absence of shift of objective lens 5. Accordingly, it is possible to provide an optical pickup device exhibiting stable tracking servo performance without degradation in luminous energy of the main beam and without occurrence of an offset due to shift of an objective lens or tilt of an information recording medium. It is noted that in this case TES becomes 0 if m is subtracted in the operation for obtaining the TES.

The present invention is not limited to the above-described embodiments, and various modifications are possible within the scope of the claims. Embodiments obtained by appropriately combining the technical means disclosed in the respective embodiments are also included in the technical range of the present invention.

As described above, the optical pickup device according to the present embodiment includes a first optical element arranged between an objective lens and an integrated unit and converting reflected light from an information recording medium to light of a second polarized state that is different from a polarized state (first polarized state) of light emitted from the integrated unit, and a second optical element arranged between the first optical element and the integrated unit and having a region preventing the light of the second polarized state from traveling straight therethrough in a portion thereof The second optical element and the objective lens are arranged such that they are driven with their relative location kept constant.

As such, part of the light of the second polarized state does not travel straight through the second optical element. Thus, the light of the second polarized state having traveled straight through the second optical element and incident on the hologram element forms a spot with a missing portion. Although the light incident on the hologram element moves thereon due to the shift of the objective lens or the tilt of the information recording medium, the shape itself does not change. Accordingly, luminous energies of the light of the second polarized state incident on sections of the hologram element separated by the missing portion do not change with the shift of the objective lens or the tilt of the information recording medium. In other words, constant tracking information of the information recording medium can be obtained regardless of shift of the objective lens or tilt of the information recording medium. Further, the light emitted from the integrated unit can be utilized without dividing the same. Accordingly, it is possible to provide an optical pickup device ensuring stable tracking servo performance, without degradation in luminous energy of a main beam or occurrence of an offset due to shift of an objective lens or tilt of an information recording medium.

In the optical pickup device of the present embodiment, the region provided at the second optical element and preventing the light of the second polarized state from traveling straight therethrough has a polarizing diffraction grating formed therein, which diffracts the light of the second polarized state.

Accordingly, the reflected light from the information recording medium incident on the region of the second optical element preventing the light of the second polarized state from traveling straight therethrough can be diffracted to enable erase, or conversely utilization, of the information included in the diffracted light.

In the optical pickup device of the present embodiment, the polarizing diffraction grating diffracts the light of the second polarized state incident from the first optical element to prevent it from entering the hologram element.

Accordingly, the information included in the light of the second polarized state diffracted by the polarizing diffraction grating can be removed more efficiently.

Alternatively, in the optical pickup device of the present embodiment, the polarizing diffraction grating may diffract the light of the second polarized state incident from the first optical element to let it enter the hologram element.

As such, it is possible to detect the information included in the light of the second polarized state traveled straight through the second optical element and the information included in the light of the second polarized state diffracted by the polarizing diffraction grating separately from each other.

In the optical pickup device of the present embodiment, the light receiving portion is configured to receive the light of the second polarized state having traveled straight through the second optical element and the light of the second polarized state diffracted by the polarizing diffraction grating, and output a signal for use in detecting a tracking error signal.

Accordingly, the offset due to the shift of the objective lens or the tilt of the information recording medium can be cancelled more efficiently in any cases including the case where the light from the light emitting portion has steep intensity distribution.

In the optical pickup device of the present embodiment, the first optical element is a quarter wave plate.

As such, the first optical element can convert the light of the first polarized state to the light of the second polarized state orthogonal thereto. Accordingly, the difference in angle of the polarized states can be maximized.

In the optical pickup device of the present embodiment, the light emitting portion is configured to emit light of the first polarized state.

Accordingly, the emitted light from the light emitting portion can wholly be utilized, which can further prevent degradation of luminous energy.

In the optical pickup device of the present embodiment, the region provided at the second optical element and preventing the light of the second polarized state from traveling straight therethrough is, a portion where the ±1st-order diffracted light from the information recording medium does not enter.

The tracking information is included in the portion where the ±1st-order diffracted light is included, and the shift information of the objective lens and the tilt information of the information recording medium are included in the other portion. Thus, when the shift signal of the objective lens and/or the tilt signal of the information recording medium is erased or cancelled, the tracking error signal can be detected without reduction of the tracking signal component.

In the optical pickup device of the present embodiment, the region provided at the second optical element and preventing the light of the second polarized state from traveling straight therethrough includes a phantom parting line bisecting the second optical element in a track direction of the information recording medium and has its area bisected by the phantom parting line.

Accordingly, it is possible to separate the shift information of the objective lens (in the radial direction of the information recording medium) and the tilt information of the information recording medium in the radial direction that are included in the light of the second polarized state incident on the region provided at the second optical element and preventing the light of the second polarized state from traveling straight therethrough. Further, the operation for detecting the tracking error signal can be facilitated.

Further, in the optical pickup device of the present embodiment, the region provided at the second optical element and preventing the light of the second polarized state from traveling straight therethrough is formed in a region of the second optical element on one side of a phantom parting line bisecting the second optical element in a radial direction of the information recording medium and between two straight lines at equal distances from the phantom parting line bisecting the second optical element in the track direction of the information recording medium.

As such, the region provided at the second optical element and preventing the light of the second polarized state from traveling straight therethrough is simple in shape, which further facilitates fabrication of the second optical element. The maximum permissible shift amount of the objective lens or the maximum permissible tilt amount of the information recording medium is associated with the shortest width of the region of the second optical element preventing the light of the second polarized state from traveling straight therethrough, which region is formed between two straight lines at equal distances from the phantom parting line in the track direction of the information recording medium. Thus, the maximum permissible shift amount of the objective lens or the maximum permissible tilt amount of the information recording medium can be estimated more easily from the distance between the two straight lines.

Further, in the optical pickup device of the present embodiment, the hologram element is a three-section hologram element that is divided into two sections by a parting line in the radial direction of the information recording medium and one of the two sections corresponding to the side on which the region preventing the light of the second polarized state from traveling straight therethrough is provided at the second optical element is further divided into two sections by a parting line in the track direction of the information recording medium.

As such, the tracking error signal can be obtained using the two sections divided by the parting line in the track direction of the information recording medium, and the focus error signal can be obtained using the remaining sections.

Hereinafter, an optical pickup device according to a second embodiment of the present invention is described with reference to FIGS. 1 and 15-25.

The optical pickup device of the present embodiment has fundamental arrangement similar to that of the first embodiment. As shown in FIG. 1, the integrated unit 1 includes a light emitting portion 2 formed of a laser diode (LD) chip, a light receiving portion 3, and a hologram element 4. An objective lens 5, a first optical element 8 and a second optical element 7 are secured to a holder 20 such that they are driven integrally for focusing and for tracking.

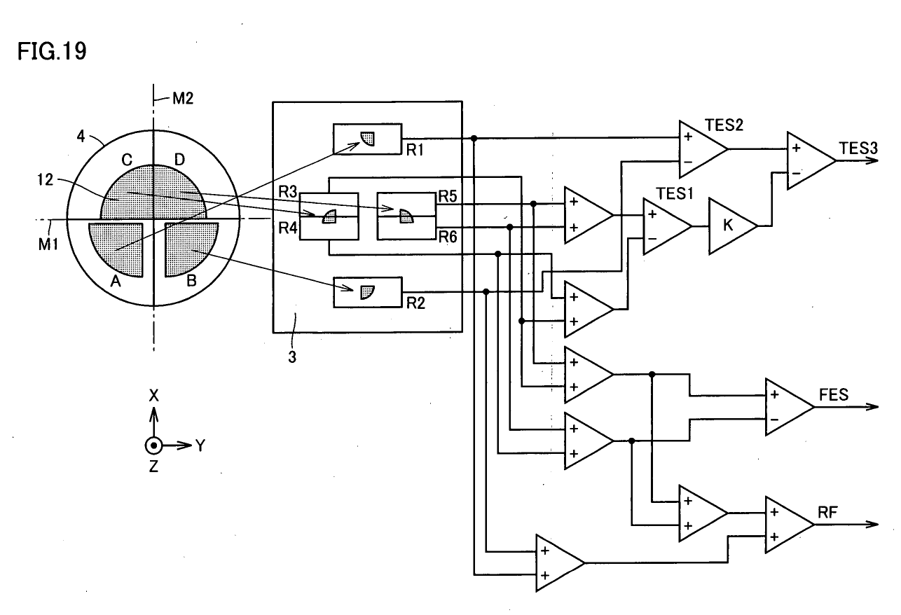

Light emitted from light emitting portion 2 of integrated unit 1 is transmitted through hologram element 4. The 0th-order light of the hologram element is transmitted through first optical element 8, second optical element 7 and objective lens 5, and converged onto an optical disk 6. The reflected light from optical disk 6 is transmitted through objective lens 5 and second optical element 8, and only a portion of the reflected light is diffracted by second optical element 7. The reflected light thus diffracted and the reflected light transmitted through second optical element 7 are made incident on hologram element 4, and the +1st-order diffracted light of hologram element 4 reaches light receiving portion 3. Hologram element 4 is a four-section hologram element that is bisected by a parting line M1 in the radial direction of optical disk 6 and further bisected by a parting line M2 in the track direction of optical disk 6 (see FIG. 19).

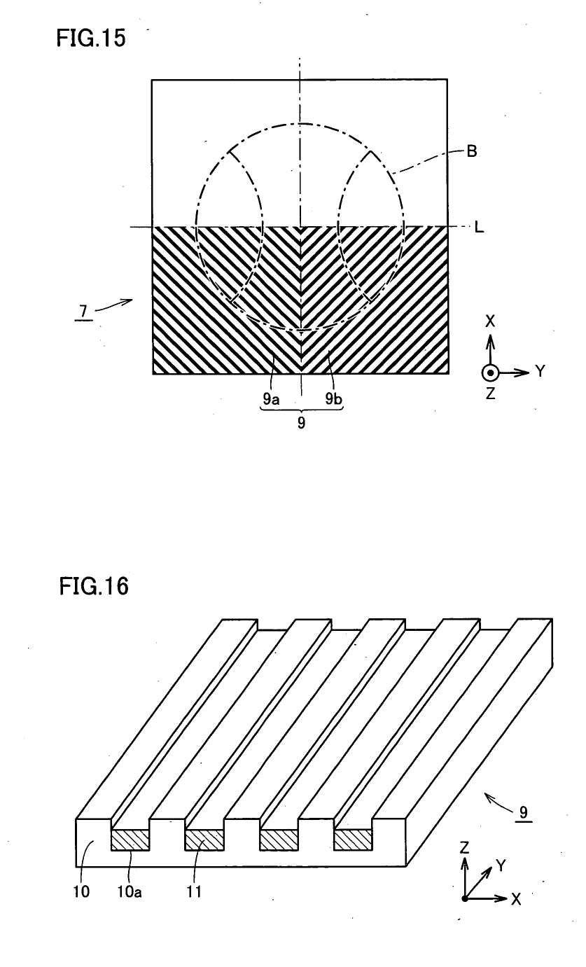

FIG. 15 shows a structure of the second optical element. In FIG. 15, an outer shape B in a circular form of the reflected light beam is shown with a dotted line. A polarizing diffraction grating 9 is formed on one side of second optical element 7 bisected by a parting line L corresponding to a half circle of the outer shape B of the reflected light beam. The other side of second optical element 7 corresponding to the other half circle of the reflected light beam is unprovided with polarizing diffraction grating 9. Parting line L passes the center of the circle of the beam outer shape B and extends in the radial direction of the optical disk.

Polarizing diffraction grating 9 is formed of polarizing diffraction gratings 9a and 9b having different grating directions from each other. A parting line of polarizing diffraction gratings 9a and 9b passes the center of the circle of the beam outer shape B and extends in the track direction of the optical disk. Thus, of the reflected light of the optical disk having reached second optical element 7, the reflected light transmitted through polarizing diffraction gratings 9a and 9b are diffracted in different directions from each other. The reflected light of the optical disk incident on the portion unprovided with polarizing diffraction grating 9 is not diffracted but transmitted through second optical element 7. The shape of the reflected light of the optical disk on hologram element 4 at this time becomes as shown in FIG. 19.

First optical element 8 is a quarter wave plate, which converts the linearly polarized light of the X direction in the drawing emitted from light emitting portion 2 into circularly polarized light, and converts the circularly polarized light of the reflected light of the optical disk into linearly polarized light of the Y direction.

FIG. 16 shows a configuration of the polarizing diffraction grating, and FIG. 17 shows a function thereof Polarizing diffraction grating 9 having a polarizing characteristic is formed of a lithium niobate substrate 10 as shown in FIG. 16, for example, as in the first embodiment. It has periodically arranged grooves 10a on its surface to form a periodic convexo-concave grating. A proton exchange region 11 is provided in groove 10a.

When the depth of groove 10a and the thickness of proton exchange region 11 are controlled appropriately, a difference between the optical path lengths of the convex and concave portions becomes an integer multiple of the wavelength for the polarized light in the X direction, while it becomes an integer multiple of the wavelength +a half wavelength for the polarized light in the Y direction. That is, as shown in FIG. 17, polarizing diffraction grating 9 lets the polarized light in the X direction travel straight therethrough without diffraction, while it diffracts the polarized light in the Y direction in accordance with the period of the grating. It however is noted that the structure of polarizing diffraction grating 9 is not limited to the one described herein.

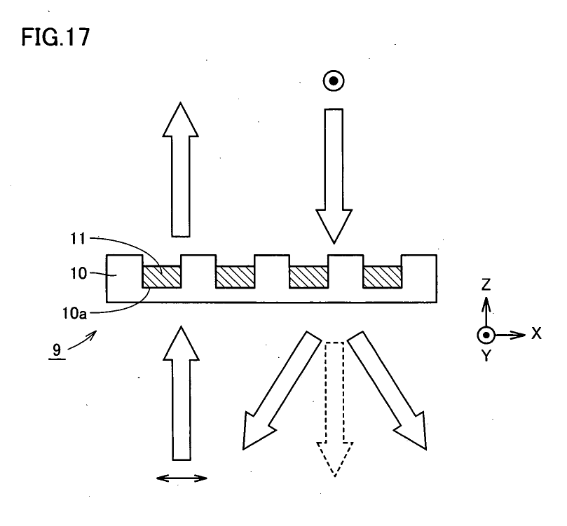

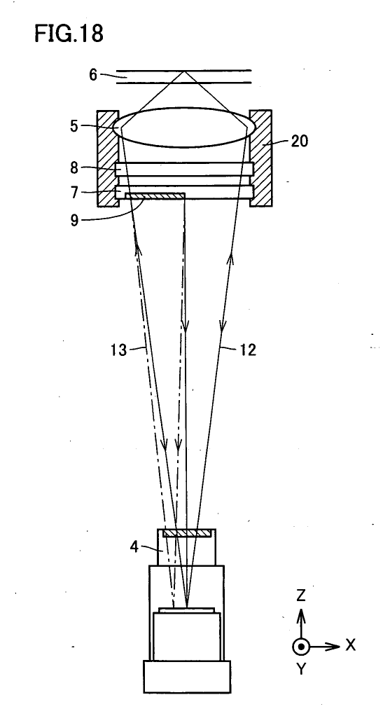

FIG. 18 is a side view showing an operation of the optical pickup device of the present embodiment. As shown in FIG. 18, the beam 12 transmitted through the portion of optical element 7 unprovided with polarizing diffraction grating 9 and the beam 13 diffracted by polarizing diffraction grating 9 are both made incident on hologram element 4.

FIG. 19 is a block diagram showing processing of signals from the light receiving portion. As shown in FIG. 19, light receiving portion 3 is divided into photodetectors R1-R6 constituting light receiving portion 3. The light incident on a region C of hologram element 4 is received at photodetectors R3 and R4, and the light incident on a region D is received at photodetectors R5 and R6. When output signals from photodetectors R3, R4, R5 and R6 are represented as S3, S4, S5 and S6, respectively, a tracking error signal TES1 is represented as (S3+S4)−(S5+S6).

The light incident on regions A and B of hologram element 4 are received at photodetectors R1 and R2, respectively, of light receiving portion 3. When output signals of photodetectors R1 and R2 are represented as S1 and S2, respectively, a tracking error signal TES2 is represented as (S1−S2). Further, a differential operation of TES1 and TES2 is performed to output a tracking error signal TES3=(S1−S2)−K {(S3+S4)−(S5+S6)}, where K is a correction coefficient.

A focus error signal FES is represented as {(S3+S5)−(S4+S6)}, and an RF signal (regenerative signal) is obtained by performing an operation of (S1+S2+S3+S4+S5+S6) for the entire beam.

In the case of reproducing a playback-only disk having pits recorded thereon, a DPD signal may be used for tracking servo. In this case, the DPD signal may be obtained by performing a comparison operation of a phase difference between (S1+S3+S4) and (S2+S5+S6) or a phase difference between S1 and S2.

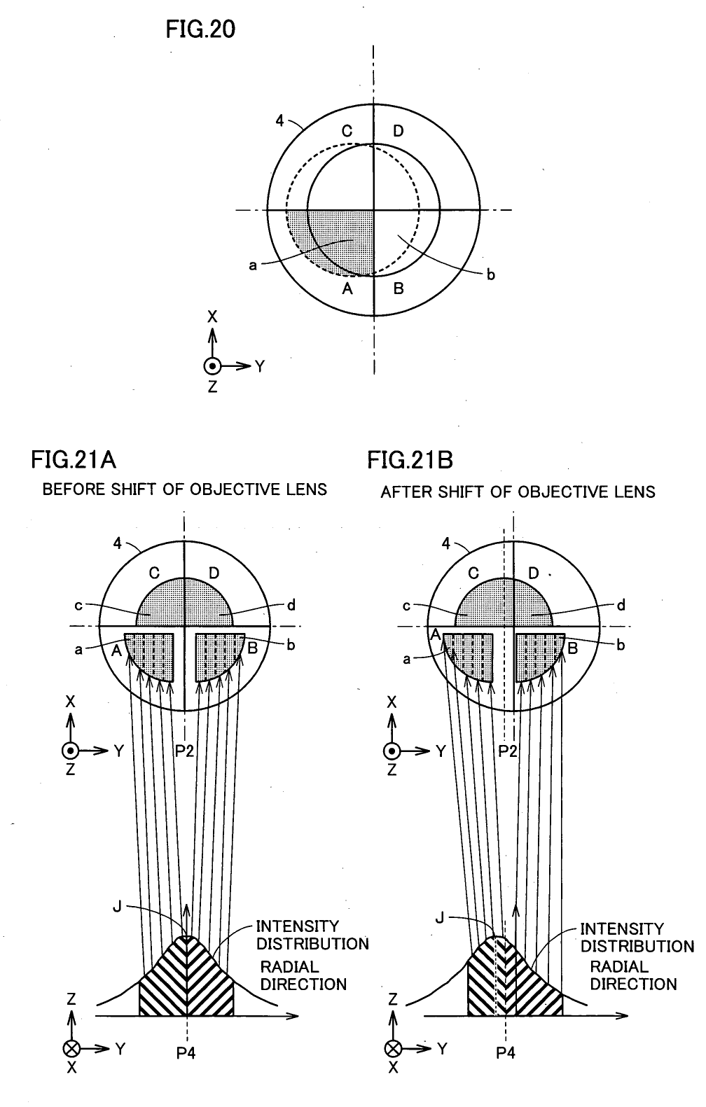

Hereinafter, the principle with which occurrence of an offset of TES3 can be suppressed even if objective lens 5 is shifted during tracking, is explained. FIG. 20 shows the relation between-a conventional hologram and light reflected from an optical disk. As shown in FIG. 20, a tracking error signal is calculated from a difference in luminous energy incident on regions A and B of the hologram. That is, the tracking error signal corresponds to the area ratio between areas a and b of the reflected light of the optical disk. Here, assume that objective lens 5 is shifted to the negative direction of the Y axis in response to decentering of optical disk 6 or the like. In this case, the reflected light on the hologram also moves to the Y-axis negative direction as shown with a dotted line.

This increases area a and decreases area b, and the resulting difference in areas a and b causes an offset of the tracking error signal even if it is actually in a just-track state.

FIGS. 21A and 21B show the relation between the position of the reflected light on the hologram and intensity distribution on the second optical element before and after shift of the objective lens, respectively. As shown in FIGS. 21A and 21B, the light diffracted and divided by second optical element 7 are made incident on sections A and B of hologram element 4, in regions a and b. The intensity on positions of regions a and b with respect to intensity distribution on second optical element 7 are as shown in FIGS. 21A and 21B. Specifically, regions a and b are the same in intensity before shift of the objecting lens. After the shift of objective lens 5, although regions a and b are the same in area, they differ in intensity distribution from each other, which is now explained in more detail.

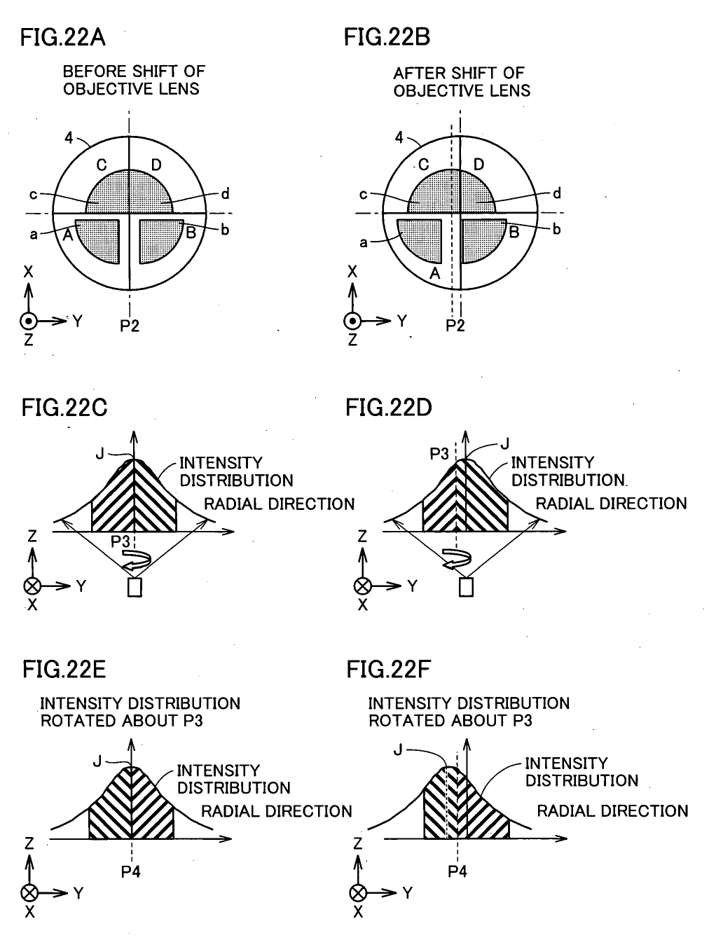

FIGS. 22A and 22B show the position of the reflected light on the hologram, FIGS. 22C and 22D show the intensity distribution of the emitted light on the second optical element, and FIGS. 22E and 22F show the intensity distribution of the reflected light on the second optical element, before and after shift of the objective lens, respectively. As seen from comparison between FIGS. 22A and 22B, when objective lens 5 is shifted in the negative direction of the Y axis, the reflected light of the optical disk also moves on hologram element 4 in the negative direction of the Y axis. At this time, although the areas of regions c and d each increase or decrease dependent on the moved amount of the reflected light, the areas of regions a and b do not change. TES2=(S1−S2)=0 holds regardless of the moved amount of the reflected light of the optical disk, and thus, no offset occurs. This however is limited to the case where the moved amount of the reflected light of the disk is less than half the distance between regions a and b on hologram element 4. Thus, the distance between regions a and b may be determined in accordance with the shifted amount of objective lens 5.

In the differential operation of TES2=(S1−S2), assume that, although a difference in area between regions a and b does not occur even if objective lens 5 is shifted in the negative direction of the Y axis (or the radial direction of the optical disk), the emitted light from light emitting portion 2 exhibits steep intensity distribution in the radial direction of the optical disk as shown in FIG. 22C. In such a case, as objective lens 5 is shifted in the negative direction of the Y axis, the center line J of intensity distribution in the radial direction of the light emitted from light emitting portion 2 and incident on objective lens 5 (i.e., the portion where the intensity of the emitted light of light emitting portion 2 becomes maximum in the radial direction), and the objective lens center line PI on objective lens 5, or the center line P2 of the reflected light on hologram element 4 corresponding to objective lens center line P1 on objective lens 5, are shifted in the radial direction of the optical disk.

Further, when the light emitted from light emitting portion 2 and incident on objective lens 5 is reflected from the optical disk, it has its intensity distribution inverted with respect to objective lens center line P1 at the time of shifting of the objective lens. As such, in the intensity distribution of the reflected light, the center J of the intensity distribution moves in the negative direction of the Y axis, as shown in FIG. 22F.

P3 in FIGS. 22C and 22D represents a position on the emitted light from light emitting portion 2 corresponding to objective lens center line P1 at the time of shifting of the objective lens. P4 in FIGS. 22E and 22F represents a position on the reflected light corresponding to objective lens center line P1 at the time of shifting of the objective lens. Thus, as seen from FIG. 22F, with respect to the shifted amount of objective lens 5, the shifted amount of the center of intensity distribution of the reflected light from the optical disk is doubled in the same direction.

As such, there occurs a difference in intensity distribution between regions a and b, hindering complete cancellation of the offset. Thus, in the expression of

TES3=(S1−S2)−K×{(S3+S4)−(S5+S6)},

the value K is optimized to make it possible to completely cancel the offset due to the shift of the objective lens in any cases. The value K depends on an angle of radiation of light emitting portion 2 in the radial direction and an effective NA of a collimator lens.

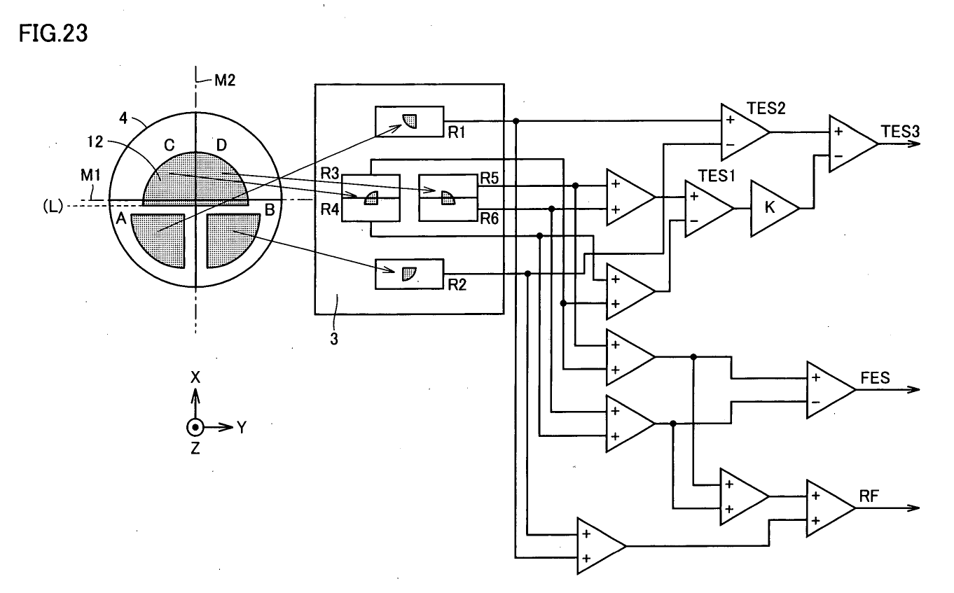

FIG. 23 is a block diagram showing processing of signals from the light receiving portion. In the FES generating method shown in FIG. 19, it has been explained that parting line L of second optical element 7 shown in FIG. 15 coincides with parting line MI of hologram element 4 shown in FIG. 19 in the X axis direction. Alternatively, when a parting line on hologram element 4 corresponding to parting line L of second optical element 7 of FIG. 15 is represented as (L), parting line M1 on hologram element 4 and parting line (L) may be set to have such positional relation as shown in FIG. 23

In this case, the parting line for use in the knife-edge method always corresponds to parting line Ml of hologram element 4 shown in FIG. 23. As such, the focus error signal is generated using parting line M1 of hologram element 4 secured to light receiving portion 3. Accordingly, the integrated unit becomes less affected by the temperature change or the change over time, and is improved in reliability.

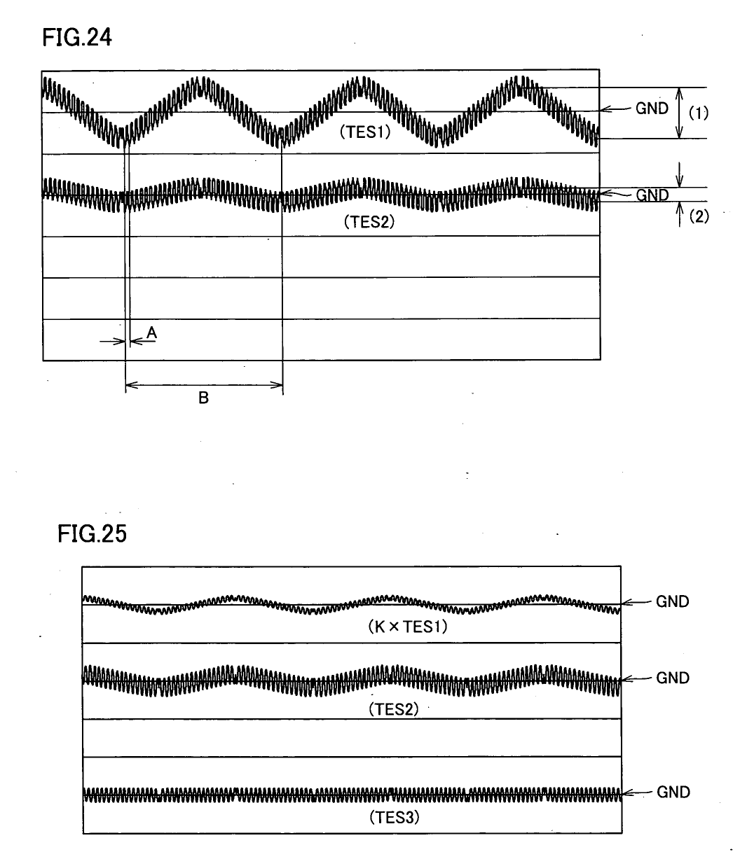

FIG. 24 shows TES1 and TES2 in the case where the angle of radiation of light emitting portion 2 in the radial direction is 9.5° and the effective NA of the collimator lens is 0.125. The push-pull signal occurred with crossing of the track corresponds to A (short period), and the offset signal component corresponds to B (long period). (2) in FIG. 24 represents the offset amount of tracking error signal TES2 upon shift of the objective lens, which occurs due to the difference in intensity distribution of the emitted light from the light emitting portion in regions a and b.

FIG. 25 shows TES1, TES2 and TES3 with the optimized value K. In the present embodiment, as shown in FIG. 25, it is possible to obtain tracking error signal TES3 suffering almost no offset due to shift of the intensity distribution of the emitted light from the light emitting portion upon the shift of the objective lens, by multiplying TES1 by 0.34 and subtracting the same from TES2.

As such, a tracking error signal suffering substantially no offset even if an objective lens is shifted, can be obtained by performing an operation of at least two kinds of tracking error signals suffering different amounts of offsets due to the shift of the objective lens.

Although it has been described that light emitting portion 2 emits linearly polarized light having a polarized direction corresponding to the X direction, it is not limited to the X direction. A similarly applicable configuration can be obtained when light emitting portion 2 emits linearly polarized light having a polarized direction corresponding to the Y direction as well. When the polarized direction of the light emitted from light emitting portion 2 corresponds to the Y direction, polarizing diffraction grating 9 shown in FIGS. 3 and 4 may be configured to transmit the polarized light in the Y direction and diffract the polarized light in the X direction. In this case, the difference between the optical path lengths of the convex and concave portions becomes “an integer multiple of wavelength” for the linearly polarized light having the polarized direction parallel to the groove direction (corresponding to the Y direction in FIG. 3), while for the linearly polarized light having the polarized direction perpendicular to the groove direction (corresponding to the X direction in FIG. 3), the difference between the optical path lengths of the convex and concave portions becomes “an integer multiple of wavelength+a half wavelength”.

As described above, according to the optical pickup device of the present invention, it is possible to correct an offset occurring due to shift of an objective lens or tilt of a disk in the 1-beam tracking method, and thus, stable track servo performance is ensured.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An optical pickup device, including an integrated unit, having a light emitting portion emitting light, a hologram element diffracting light reflected from an information recording medium and a light receiving portion receiving the light diffracted by said hologram element, and an objective lens for converging the light emitted from said integrated unit onto the information recording medium, comprising:
a first optical element arranged between said objective lens and said integrated unit and converting the reflected light from the information recording medium to light of a second polarized state that is different from a first polarized state corresponding to a polarized state of the light emitted from said integrated unit; and
a second optical element arranged between said first optical element and said integrated unit and having at least a portion provided with a region preventing the light of the second polarized state from traveling straight therethrough, wherein
said second optical element and said objective lens are driven with their relative location kept constant.

2. The optical pickup device according to claim 1, wherein the region provided at said second optical element and preventing the light of the second polarized state from traveling straight therethrough has a polarizing diffraction grating diffracting the light of the second polarized state formed therein.

3. The optical pickup device according to claim 2, wherein said polarizing diffraction grating diffracts the light of the second polarized state incident from said first optical element to prevent the diffracted light from entering said hologram element.

4. The optical pickup device according to claim 2, wherein said polarizing diffraction grating diffracts the light of the second polarized state incident from said first optical element to let the diffracted light enter said hologram element.

5. The optical pickup device according to claim 4, wherein said light receiving portion is configured to receive the light of the second polarized state having traveled straight through said second optical element and the light of the second polarized state diffracted by said polarizing diffraction grating, and output a signal for use in detecting a tracking error signal.

6. The optical pickup device according to claim 1, wherein said first optical element is a quarter wave plate.

7. The optical pickup device according to claim 1, wherein said light emitting portion is configured to emit light of the first polarized state.

8. The optical pickup device according to claim 1, wherein the region provided at said second optical element and preventing the light of the second polarized state from traveling straight therethrough is a portion where the ±1st-order diffracted light from the information recording medium does not enter.

9. The optical pickup device according to claim 8, wherein the region provided at said second optical element and preventing the light of the second polarized state from traveling straight therethrough includes a phantom parting line bisecting said second optical element in a track direction of the information recording medium and has its area bisected by the phantom parting line.

10. The optical pickup device according to claim 9, wherein the region provided at said second optical element and preventing the light of the second polarized state from traveling straight therethrough is formed in a region of said second optical element on one side of a phantom parting line bisecting said second optical element in a radial direction of the information recording medium and between two straight lines at equal distances from the phantom parting line bisecting said second optical element in the track direction of the information recording medium.

11. The optical pickup device according to claim 10, wherein said hologram element is a three-section hologram element that is divided into two sections by a parting line in the radial direction of the information recording medium and one of the two sections corresponding to the side on which the region preventing the light of the second polarized state from traveling straight therethrough is provided at said second optical element is further divided into two sections by a parting line in the track direction of the information recording medium.

12. An optical pickup device, including an integrated unit, having a light emitting portion emitting light, a hologram element diffracting light reflected from an optical disk to guide the light to a light receiving portion, and the light receiving portion receiving the light diffracted by said hologram element, and an objective lens for converging the light emitted from said light emitting portion of said integrated unit onto the optical disk, comprising:
a first optical element arranged between said objective lens and said integrated unit, and a second optical element arranged between said first optical element and said integrated unit, wherein
said second optical element has a diffracting portion diffracting a portion of the reflected light from the optical disk, said diffracting portion having anisotropy in polarization to transmit light of a first linearly polarized state therethrough and to diffract light of a second linearly polarized state having a polarized direction orthogonal to a polarized direction of said first linearly polarized state,
said first optical element converts the polarized state of the reflected light from the optical disk to said second linearly polarized state, and
said first and second optical elements and said objective lens are provided integrally.

13. The optical pickup device according to claim 12, wherein said first optical element is a quarter wave plate that converts the first linearly polarized state to a circularly polarized state, and converts the circularly polarized state to the second linearly polarized state.

14. The optical pickup device according to claim 12, wherein the diffracting portion of said second optical element is a polarizing diffraction grating that is provided at only a portion of said second optical element corresponding to a portion of the reflected light of the optical disk.

15. The optical pickup device according to claim 14, wherein the polarizing diffraction grating constituting the diffracting portion of said second optical element is formed of a lithium niobate substrate having periodically arranged grooves on its surface and proton exchange regions provided in said grooves.

16. The optical pickup device according to claim 12, wherein a portion of the reflected light of the optical disk diffracted by said diffracting portion of said second optical element and another portion of the reflected light of the optical disk transmitted through said second optical element are both made incident on said hologram element of said integrated unit.

17. The optical pickup device according to claim 12, wherein the diffracting portion of said second optical element is provided on one of two portions of said second optical element divided by a parting line in a radial direction of the optical disk.

18. The optical pickup device according to claim 12, wherein said light emitting portion emits laser light of the first linearly polarized state.

19. The optical pickup device according to claim 12, wherein said hologram element of said integrated unit is a four-section hologram element that is divided into two sections by a parting line in a radial direction of the optical disk and further divided into two sections by a parting line in a track direction of the optical disk.

20. The optical pickup device according to claim 19, wherein said light receiving portion of said integrated unit is divided into at least four sections in response to the diffracted light divided into four portions by said hologram element.

21. The optical pickup device according to claim 19, wherein the reflected light of the optical disk transmitted through said second optical element without diffraction is further divided into two portions by the parting line in the optical disk radial direction of said hologram element.

22. The optical pickup device according to claim 12, wherein
said light receiving portion is divided into a plurality of sections, and
a first tracking error signal, generated from a signal of the section of said light receiving portion where the reflected light of the optical disk transmitted through said second optical element without diffraction enters, and a second tracking error signal, generated from a signal of the section of said light receiving portion where the reflected light of the optical disk diffracted by said second optical element enters, are used to perform an operation to detect a third tracking error signal for use in tracking.
